(19) United States
(12) Patent Application Publication
(10) Pub. No.: US 2025/0018696 A1
(43) Pub. Date: Jan. 16, 2025

(54) MULTICOMPONENT STRUCTURES WITH IMPROVED MECHANICAL PERFORMANCE

(71) Applicant: Peak Nano Films, LLC, Valley View, OH (US)

(72) Inventors: Michael Ponting, Broadview Heights, OH (US); Wendy Hoenig, Spring, TX (US); Deepak Langhe, Cypress, TX (US); Joseph L. Lenhart, Port Deposit, MD (US)

(73) Assignee: Peak Nano Films, LLC, Valley View, OH (US)

(21) Appl. No.: 18/809,776

(22) Filed: Aug. 20, 2024

Related U.S. Application Data
(63) Continuation-in-part of application No. 17/174,034, filed on Feb. 11, 2021.
(60) Provisional application No. 62/975,855, filed on Feb. 13, 2020.

(51) Int. Cl. B32B 27/08; B32B 3/18; B32B 5/02; B32B 27/12

(52) U.S. Cl. CPC B32B 27/08; B32B 3/18; B32B 5/02; B32B 27/12; B32B 2272/00; B32B 2307/206; B32B 2307/54; B32B 2307/7376

(57) ABSTRACT

A multicomponent structure includes a substrate having a plurality of fiber-like reinforcement materials embedded in a matrix material. The reinforcement materials have a rectangular cross-section defined in part by the matrix material and extend a length of the multicomponent structure. In one embodiment, the multicomponent structure includes at least one recyclate.

### CROSS-REFERENCES TO RELATED APPLICATIONS

This application relates to and claims priority from the following U.S. patent applications. This application is a continuation-in-part of U.S. patent application Ser. No. 17/174,034, filed Feb. 11, 2021, which claims priority from U.S. Provisional Patent Application No. 62/975,855, filed Feb. 13, 2020, each of which is incorporated herein by reference in its entirety.

### TECHNICAL FIELD

The present invention relates to polymers and polymer with fillers to form composites, in particular, relates to multilayer films and sheets that can form multicomponent structures.

### BACKGROUND

Fibers, including micro- and nano-fibers, can be added to composites to expand or add novel performance attributes, such as reduction in weight, breathability, moisture wicking, increased absorbency, increased reaction rate, etc. Application of fiber containing composites are rapidly growing and promise to be diverse. Applications include filtration, barrier fabrics, insulation, absorbable pads and wipes, personal care, biomedical and pharmaceutical applications, enhanced web opacity, nucleators, reinforcing agents, acoustic substrates, apparel, energy storage, etc. Due to their limited mechanical properties that preclude the use of conventional web handing, loosely interlaced fibers are often applied to a supporting substrate, such as a non-woven or fabric material and often an adhesive is applied to improve the adhesion between the fibers and the substrate. The bonding of the fiber cross over points may be able to increase the mechanical strength of the fiber non-wovens which potentially help with their mechanical handling and offer superior physical performance.

US. Patent Publication No. 2010/098925 for Multi-layer nanocomposite materials and methods for forming the same by inventors Fasulo et al., filed Oct. 6, 2006 and published Apr. 22, 2010, is directed to a multi-layer nanocomposite material includes a first layer of a first polymeric material and a second layer of nanocomposite material. The nanocomposite material includes a second polymeric material and a nanofiller material exfoliated therewithin. The second layer is established on the first layer, or the first layer is established on the second layer. The multi-layer nanocomposite material exhibits enhanced physical properties and enhanced ductility due to the improved stress dissipation of the secondary layers during impact.

U.S. Pat. No. 10,759,139 for Multicomponent layered dielectric film and uses thereof by inventor Ponting, filed Dec. 4, 2015 and issued Sep. 1, 2020, is directed to a multicomponent dielectric film includes discrete overlapping dielectric layers of at least a first polymer material, a second polymer material, and a third polymer material. Adjoining dielectric layers define a generally planar interface therebetween which lies generally in an x-y plane of an x-y-z coordinate system. The interfaces between the layers delocalizing the charge build up in the layers. At least one dielectric layer including a stack of discrete polymer layers with polymer layer interfaces extending transverse to the x-y plane and optionally at least one filler having a higher dielectric constant than the first polymer material, the second polymer material, and/or the third polymer material.

U.S. Pat. No. 10,077,509 for Production of micro- and nano-fibers by continuous microlayer coextrusion by inventors Baer et al., filed Apr. 15, 2013 and issued Sep. 18, 2018, is directed to a multilayered polymer composite film includes a first polymer material forming a polymer matrix and a second polymer material coextruded with the first polymer material. The second polymer material forms a plurality of fibers embedded within the polymer matrix. The fibers have a rectangular cross-section.

### SUMMARY

Embodiments described herein relate to multicomponent structures that include a multicomponent substrate having a plurality of fiber-like reinforcement materials (e.g., polymer reinforcement layers) embedded in a matrix material (e.g., polymer matrix). The reinforcement materials can have a substantially rectangular cross-section defined in part by the matrix material and the fabrication process and extend a length of the multicomponent structure. The multicomponent structure can be produced by, for example, extrusion, coextrusion, lamination, and/or 3D printing techniques, and be used to produce tougher composite systems for various applications including but not limited to ballistics, fracture resistant packaging and windows, and automotive or consumer products.

In some embodiments, the multicomponent structure can include a multilayer polymer film or sheet that includes a plurality of discrete polymer layers that define the plurality of polymer reinforcements in the polymer matrix. The discrete polymer layers can at least partially overlap to define the polymer reinforcements. The plurality of discrete polymer layers can include a plurality of polymer layers and the polymer matrix can be defined by a plurality of other polymer layers.

The multicomponent structure can have a gradient layer structure or packets of layers with different individual layer thicknesses. The multicomponent structure can also contain multiple such packets with each packet of layers containing two or more layer thickness variations.

In other embodiments, the multicomponent structure can include a vertical stack of overlapping first layers and second layers that can adhere to one another. Adjoining first layers and second layers of the stack can define a generally planar interfaces therebetween, which lies generally in an x-y plane of an x-y-z coordinate system. The first layers of the vertical stack of layers can include a first material. The second layers can include a horizontal stack of discrete layers with layer interfaces extending transverse to the x-y plane. The layers of the horizontal stack of discrete layers can include alternating layers of at least a second material and a third material. The structure is such that the second layers include fiber-like reinforcement layers having a substantially rectangular cross-section that extend substantially parallel to the x-y plane in a matrix defined in part by the first material and the second material.

In some embodiments, the first material, second material, and third material can include an inorganic material, organic material, and/or blend thereof that can be readily extruded, coextruded, laminated, 3D printed and/or processed by some other means into the first layers, second layers, and/or third layers. In still other embodiments, the first material, second material, and third material include a melt-processable inorganic material, organic material, and/or blend thereof.

In other embodiments, the multicomponent structure can be in the form of a multilayer polymer film or sheet that includes a plurality of polymer material reinforcement layers having a substantially rectangular cross-section embedded within a polymer matrix of the multilayer polymer film or sheet. The polymer reinforcement layers can have a substantially rectangular cross-section defined in part by the polymer matrix material and extend a length of the multilayer film or sheet. Each of the polymer reinforcement layers can be separated from one another by the polymer matrix. In some embodiments, each of polymer reinforcement layers can extend parallel to one another from a first end of the film to second end of the film.

In other embodiments, at least one of the first polymer material, second polymer material, or third polymer material can include a blend or mixture of two or more polymers. The two or more polymers can be miscible with each other to allow extrusion of the polymer mixture or blend.

In some embodiments, the multicomponent structure can include about 2 to about 2,000,000 alternating first layers and second layers fabricated by multilayer coextrusion forced assembly processes.

Other embodiments described herein relate to a method of producing a multicomponent structure. The method can include coextruding at least two (e.g., two, three, or more) polymer materials to form a multilayered polymer composite stream that includes pluralities of polymer layers formed from each polymer material. Each polymer layer can have a rectangular cross-section and be continuous or discontinuous in the multilayered polymer composite stream. The multilayered composite stream can be coextruded with at least one additional polymer material such that other polymer layers form polymer reinforcements having a rectangular cross-section that extend substantially parallel in a polymer matrix defined in part by the other polymer layers and the coextruded additional polymer material.

In some embodiments, the mechanical properties of the multicomponent structure so formed can be varied mechanically by axially orienting (e.g., stretching), pressure, tension, compression or shear stresses or a combination of these stresses. The structure can be fabricated so that one or both of the component materials is an elastomer. Axial orientation of the multicomponent structure in at least one direction parallel to the surface of the structure can in some instances increase or improve the mechanical strength or toughness of the structure. In one example, the multicomponent structure can be a multicomponent film or sheet, which can be uniaxially oriented by stretching the film in a plane that is substantially parallel to a surface of the film or sheet at a draw ratio effective to increase the mechanical strength of the film or sheet. The draw ratio of the uniaxially oriented multilayer polymer film or sheet can be about 1:1 to about 1:50. It will be appreciated that although the film or sheet can be uniaxially oriented by stretching the film or sheet in at least two one direction, the film or sheet can also be stretched in at least two directions (e.g., biaxially oriented) or stretched in multiple directions (e.g., triaxially oriented).

Other objects and advantages and a fuller understanding of the invention will be had from the following detailed description of the preferred embodiments and the accompanying drawings.

### BRIEF DESCRIPTION OF THE DRAWINGS

FIG. 1 is a schematic illustration of a multicomponent structure in accordance with an embodiment.

FIG. 2 is a schematic illustration of a co-extrusion and layer multiplying process used to form a multicomponent structure in accordance with an embodiment.

FIG. 3 is a schematic illustration of coextruding skin layers onto a composite film of FIG. 2 to form a composite stream.

FIG. 4 is a schematic illustration of additional layer multiplying steps for the composite stream of FIG. 3.

FIG. 5A is schematic illustration of film cross-section showing 2D layer structure according to one embodiment of the present invention.

FIG. 5B is schematic illustration of film cross-section showing 2D layer structure according to one embodiment of the present invention.

FIG. 5C is schematic illustration of film cross-section showing 2D layer structure according to one embodiment of the present invention.

FIG. 5D is schematic illustration of film cross-section showing 2D layer structure according to one embodiment of the present invention.

FIG. 6 is a chart comparing mechanical properties of a layered HDPE structure versus an unlayered HDPE structure according to one embodiment of the present invention.

FIG. 7 is a chart comparing Young's moduli of a layered HDPE structure versus an unlayered HDPE structure according to one embodiment of the present invention.

FIG. 8 is a chart comparing ultimate stress of a layered HDPE structure versus an unlayered HDPE structure according to one embodiment of the present invention.

FIG. 9 is a chart comparing ultimate strain of a layered HDPE structure versus an unlayered HDPE structure according to one embodiment of the present invention.

FIG. 10 is a chart comparing mechanical properties of a layered HDPE/EVOH structure versus an unlayered HDPE/EVOH structure according to one embodiment of the present invention.

FIG. 11 is a chart comparing Young's moduli of a layered HDPE/EVOH structure versus an unlayered HDPE/EVOH structure according to one embodiment of the present invention.

FIG. 12 is a chart comparing ultimate stress of a layered HDPE/EVOH structure versus an unlayered HDPE/EVOH structure according to one embodiment of the present invention.

FIG. 13 is a chart comparing ultimate strain of a layered HDPE/EVOH structure versus an unlayered HDPE/EVOH structure according to one embodiment of the present invention.

### DETAILED DESCRIPTION

Embodiments described herein relate to multicomponent structures that include a multicomponent substrate having a plurality of fiber-like reinforcement materials (e.g., polymer reinforcement layers) embedded in a matrix material (e.g., polymer matrix material). The reinforcement materials can have a substantially rectangular cross-section defined in part by the matrix material and the fabrication process and extend a length of the multicomponent structure. The multicomponent structure can be produced by, for example, extrusion, coextrusion, lamination, and/or 3D printing techniques, and be used to produce tougher composite systems for various applications including but not limited to ballistics, packaging, and automotive or consumer products.

The multicomponent structure of the present invention is able to be used for nonwoven apparel, diapers, feminine hygiene, incontinence hygiene pads, medical gauze, medical drapes, medical bed protection pads, surgical gowns, filtration including medical, pharmaceutical, food & beverage, automotive, industrial, HVAC, chemical processing, mining, fiber/film laminates for medical absorbent pads, industrial remediation absorbent pads, filtration for drinking water, industrial, and food preparation, waste water effluent, impact resistance windows, helmets, body armor, and sewage water treatment (e.g. desalination treatment).

In some embodiments, the multicomponent structure can include a multilayer polymer film or sheet that includes a plurality of discrete polymer layers that define a plurality polymer reinforcements in the polymer matrix. The discrete polymer layers can at least partially overlap to define the polymer reinforcements.

The multicomponent structure can have a gradient layer structure or packets of layers with different individual layer thicknesses. The multicomponent structure can also contain multiple such packets with each packet of layers containing two or more layer thickness variations.

In other embodiments, the multicomponent structure can include a vertical stack of overlapping first layers and second layers that can adhere to one another. Adjoining first layers and second layers of the stack can define a generally planar interfaces therebetween, which lie generally in an x-y plane of an x-y-z coordinate system. The first layers of the vertical stack of layers can include a first material. The second layers can include a horizontal stack of discrete layers with layer interfaces extending transverse to the x-y plane. The layers of the horizontal stack of discrete layers can include alternating layers of at least a second material and a third material.

In some embodiments, the first material, second material, and third material can include an inorganic and/or organic material and blends thereof that can be readily extruded, coextruded, laminated, 3D printed and/or processed by some other means into the first layers, second layers, and/or third layers. In still other embodiments, the first material, second material, and third material include a melt-processable inorganic and/or organic material (e.g., polymer material).

In other embodiments, the multicomponent structure can be in the form of a multilayer polymer film or sheet that includes a plurality of polymer material reinforcement layers having a substantially rectangular cross-section embedded within a polymer matrix of the multilayer polymer film or sheet. The polymer reinforcement layers can have a substantially rectangular cross-section defined in part by the polymer matrix material and extend a length of the multilayer film or sheet. Each of the polymer reinforcement layers can be separated from one another by the polymer matrix. In some embodiments, each of polymer reinforcement layers can extend parallel to one another from a first end of the film or sheet to second end of the film or sheet.

In other embodiments, at least one of the first polymer material, second polymer material, or third polymer material can include a blend or mixture of two or more polymers.

In some embodiments, the multicomponent structure can include about 2 to about 2,000,000 alternating first layers and second layers fabricated by multilayer coextrusion forced assembly processes.

Other embodiments described herein relate to a method of producing a multicomponent structure. The method can include coextruding at least two (e.g., two, three, four, or more) polymer materials to form a multilayered polymer composite stream that includes pluralities of polymer layers formed from each polymer material. Each polymer layer can have a rectangular cross-section and be continuous or discontinuous in the multilayered polymer composite stream. The multilayered composite stream can be coextruded with at least one additional polymer material such that other polymer layers form polymer reinforcements having a rectangular cross-section that extend substantially parallel in a polymer matrix defined in part by the other polymer layers and the coextruded additional polymer material.

In some embodiments, the mechanical properties of the multicomponent structure so formed can be varied mechanically by axially orienting (e.g., stretching), pressure, tension, compression or shear stresses or a combination of these stresses. The multicomponent structure can be fabricated so that one or both of the component materials is an elastomer. Axial orientation of the multicomponent structure in at least one direction parallel to the surface of the structure can in some instances increase or improve the mechanical strength or toughness of the structure. In one example, the multicomponent structure can be a multicomponent film or sheet, which can be uniaxially oriented by stretching the film or sheet in a plane that is substantially parallel to a surface of the film or sheet at a draw ratio effective to increase the mechanical strength of the film or sheet. The draw ratio of the uniaxially oriented multilayer polymer film or sheet can be about 1:1 to about 1:50. It will be appreciated that although the film or sheet can be uniaxially oriented by stretching the film or sheet in at least two one direction, the film or sheet can also be stretched in at least two directions (e.g., biaxially oriented) or stretched in multiple directions (e.g., triaxially oriented).

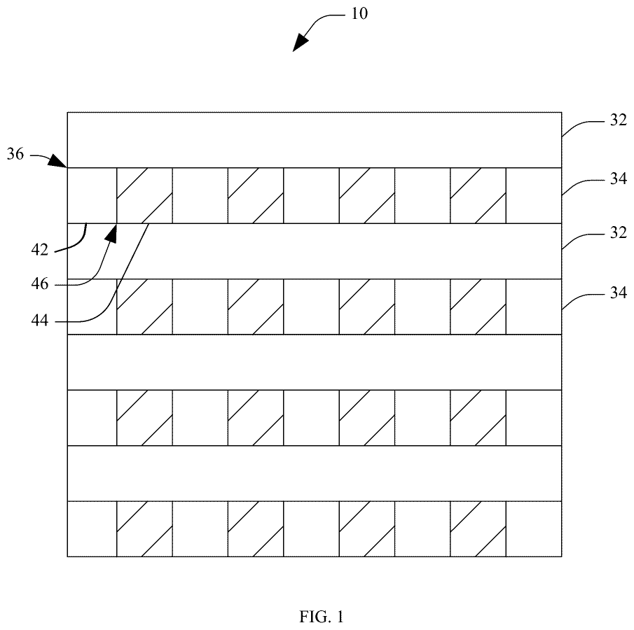

FIG. 1 illustrates a multicomponent structure 30 that includes a plurality of alternating first polymer layers 32 of a first polymer material and second polymer layers 34 of a second polymer material and a third polymer material. The first polymer layers 32 and the second polymer layers 34 can be substantially parallel and vertically stacked so that each first polymer layer 32 is adjacent to at least one of the second polymer layers 34 and defines an interface 36 between each layer. The second polymer layers 34 can include a horizontal stack 40 of third polymer layers 42 of the second polymer material and fourth polymer layers 44 of the third polymer material with interfaces 46 perpendicular or transverse to the interface 36 of the layers. The horizontally stacked third polymer layers 42 of the second polymer material and fourth polymer layers 44 of the third polymer material can have substantially rectangular cross-sections that extend the lengths of layers 42 and 44.

The first polymer layers 32 and the second polymer layers 34, which include the third polymer layers 42 and the fourth polymer layers 44, can have various thicknesses, for example, about 5 to about 5000 nm, which can be readily varied. Similarly, the width of third polymer layers 42 and the fourth polymer layers 44, can have various thicknesses, for example, about 5 to about 5000 nm, which can be readily varied.

Optionally, the first polymer layer and the second polymer layer can include one or more additives to vary and/or improve the mechanical properties of the multicomponent structure. For example, the first polymer layer and/or the second polymer layer can include about 1% to about 50% by volume of a filler or blend of two or more fillers or particle sizes to improve the mechanical properties of the host polymer. The non-polymeric filler can include particles, fibers, or other fillers.

In one embodiment, the particles provided in the multicomponent structure may include any suitably sized particle, including nano-particles, micron-sized particles or larger. “Nano-particle” refers to any particle with at least one dimension less than one micron. “Micron-sized” particle refers to any particle with at least one dimension less than 1 mm. The particles may be, but are not limited to, spherical, cubic, cylindrical, platelet, and irregular. The particles can have at least one dimension less than 1 mm, less than 500 μm, less than 200 μm, less than 100 μm, less than 50 μm, less than 1 μm, less than 800 nm, for example, less than 500 nm, less than 200 nm, less than 100 nm. The particles may be organic or inorganic.

Examples of organic particles, fibers, or other fillers include Buckminster fullerenes (fullerenes), dendrimers, organic polymeric nanospheres, amino acids, organic glass, high temperature or glass transition temperature plastic fibers, and linear or branched or hyperbranched “star” polymers such as 4, 6, or 8 armed polyethylene oxide with a variety of end groups, polystyrene, superabsorbing polymers, silicones, crosslinked rubbers, phenolics, melamine formaldehyde, urea formaldehyde, chitosan or other biomolecules, and organic pigments (including metallized dyes and titanium dioxide).

Examples of inorganic particles, fibers, and/or other fillers include, but are not limited to, calcium carbonate, calcium phosphate (e.g., hydroxy-apatite), talc, mica, clays, metal oxides, metal hydroxides, metal sulfates, metal phosphates, silica, zirconia, titania, ceria, alumina, iron oxide, vanadia, antimony oxide, tin oxide, alumina/silica, zirconium oxide, gold, silver, cadmium selenium, inorganic glasses like boro-silicates, chalcogenides, zeolites, nanotubes, quantum dots, salts such as CaCO₃, magnetic particles, metal-organic frameworks, and any combinations thereof.

In some embodiments, the particles can be further functionalized. For example, via further chemistry, the surface of the particles may have added functionality (reactivity, catalytically functional, electrical or thermal conductivity, chemical selectivity, light absorption) or modified surface energy for improved adhesion, optical properties, mechanical toughening, strength, processing, electrical performance, or solubility in certain applications.

The first polymer material of the first polymer layer 32, the second polymer material of the third polymer layer 42, and the third polymer material of the fourth polymer layer 44 can be selected such that the second polymer material can be miscible and/or soluble with the first polymer material of the first polymer layers 32 and at least some miscibility with the third polymer material of the fourth polymer layers 44. As such, during and/or after extrusion of the first polymer layers 32 and second polymer layers 34, first polymer material of the first polymer layers 32 and the second polymer material third polymer layers 42 can adhere, diffuse, blend, and/or consolidate such that the first polymer layers 32 and third polymer layers 42 form and/or define continuous polymer matrix that encompasses or surrounds the fourth polymer layers 44. The fourth polymer layers 44 form polymer fiber-like reinforcement layers having a rectangular cross-section that extend substantially parallel in the polymer matrix defined in part by the first polymer material of the first polymer layer 32 and the second polymer material of the third polymer layer 42.

The first polymer material and/or second polymer material can comprise a single polymer, a composite polymer material, or a blend of polymers. In some embodiments, the first polymer material can be the same or substantially the same as the second polymer material such that the first polymer material is substantially miscible with second polymer during and/or after extrusion. In another embodiment, the first polymer material and the second polymer material are not the same, but the two materials are miscible with each other.

The third polymer can comprise a single polymer, a composite polymer material, or a blend of polymers.

In some embodiments, the first polymer material, second polymer material, and third polymer material can include melt-processable polymer materials that can be readily coextruded. Such polymer materials can include thermoplastic polymer materials, glassy polymers, crystalline polymers, and elastomers. The term “thermoplastic” includes a material that is plastic or deformable, melts to a liquid when heated and freezes to a brittle, glassy state when cooled sufficiently. The first polymer material, second polymer material, and third polymer material, may be selected from any thermoplastic polymers that meet the conditions stated above, are melt-processable, and are suitable for use in the end product.

Examples of polymers for the first polymer material, second polymer material, or third polymer material include, but are not limited to polyacetals, polyacrylics, polycarbonates, polystyrenes, polyolefins, polyesters, polyamides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polyphenylenesulfides, polythioesters, polysulfones, polysulfonamides, polyureas, polyphosphazenes, polysilazanes, polypropylenes, polyethylenes, polymethylpentene (and co-polymers thereof), polynorbornene (and co-polymers thereof), polyethylene terephthalates, Polychlorotrifluoroethylene, polyvinylidene fluorides, polysiloxanes, polylactic acid, Polyhydroxybutyrate, starches, poly or the like, or a combination comprising at least one of the foregoing thermoplastic polymers.

In some embodiments, polyolefins include polyethylene, cyclic olefin copolymers, poly(alpha-olefin)s. As used herein, poly(alpha-olefin) means a polymer made by polymerizing an alpha-olefin. An alpha-olefin is an alkene where the carbon-carbon double bond starts at the alpha-carbon atom. Examples of poly(alpha-olefin) s include polypropylene, poly(1-butene) and polystyrene. Examples polyesters include condensation polymers of a C₂₋₁₂ dicarboxylic acid and a C₂₋₁₂ alkylenediol. Examples of polyamides include condensation polymers of a C₂₋₁₂ dicarboxylic acid and a C₂₋₁₂ alkylenediamine. Additionally, the first polymer material, second polymer material, and/or third polymer material may be copolymers and blends of polyolefins, styrene copolymers and terpolymers, ionomers, ethyl vinyl acetate, polyvinylbutyrate, polyvinyl chloride, metallocene polyolefins, poly(alpha olefins), ethylene-propylene-diene terpolymers, fluorocarbon elastomers, other fluorine-containing polymers, polyester polymers and copolymers, polyamide polymers and copolymers, polyurethanes, polycarbonates, polyketones, and polyureas, as well as polycaprolactam (Nylon 6).

In one embodiment, the polymers can include, for example, high density polyethylene, linear low density polyethylene, ethylene alpha-olefin copolymers, polypropylene, poly(vinylidene fluoride), poly(vinyl fluoride), poly(ethylene chlorotrifluoroethylene), polyoxymethylene, poly(ethylene oxide), ethylene-vinyl alcohol copolymer, and blends thereof. Blends of one or more compatible polymers may also be used. Particular polymers are polyolefins, such as polypropylene and polyethylene, that are readily available at low cost and may provide highly desirable properties in the multicomponent structures described herein, such properties including high modulus and high tensile strength.

Polyamide polymers include, but are not limited to, synthetic linear polyamides, e.g., nylon-6, nylon-6,6, nylon-11, or nylon-12. Polyurethane polymers which may be used include aliphatic, cycloaliphatic, aromatic, and polycyclic polyurethanes. Also useful are polyacrylates and polymethacrylates, which include, for example, polymers of acrylic acid, methyl acrylate, ethyl acrylate, acrylamide, methylacrylic acid, methyl methacrylate, n-butyl acrylate, and ethyl acrylate, to name a few. Other useful substantially extrudable hydrocarbon polymers include polyesters, polycarbonates, polyketones, and polyureas. Useful fluorine-containing polymers include crystalline or partially crystalline polymers such as copolymers of tetrafluoroethylene with one or more other monomers such as perfluoro(methyl vinyl)ether, hexafluoropropylene, perfluoro(propyl vinyl)ether; copolymers of tetrafluoroethylene with ethylenically unsaturated hydrocarbon monomers such as ethylene, or propylene.

Representative examples of polyolefins are polyethylene, polypropylene, polybutylene, polymethylpentene (and co-polymers thereof), polynorbornene (and co-polymers thereof), poly 1-butene, poly(3-methylbutene), poly(4-methylpentene) and copolymers of ethylene with propylene, 1-butene, 1-hexene, 1-octene, 1-decene, 4-methyl-1-pentene and 1-octadecene. Representative blends of polyolefins are blends containing polyethylene and polypropylene, low-density polyethylene and high-density polyethylene, and polyethylene and olefin copolymers containing the copolymerizable monomers, some of which are described above, e.g., ethylene and acrylic acid copolymers; ethyl and methyl acrylate copolymers; ethylene and ethyl acrylate copolymers; ethylene and vinyl acetate copolymers-, ethylene, acrylic acid, and ethyl acrylate copolymers, and ethylene, acrylic acid, and vinyl acetate copolymers.

The thermoplastic polymers may include blends of homo- and copolymers, as well as blends of two or more homo- or copolymers. The two polymers can be blended while both are in the molten state, meaning that the conditions are such (temperature, pressure) that the temperature is above the melting temperature (or softening temperature) of both of the polymers to ensure good mixing. This is typically done in an extruder. Miscibility and compatibility of polymers are determined by both thermodynamic and kinetic considerations. A listing of polymers may also be found in PCT published application WO2008/028134, which is incorporated in its entirety by reference.

The thermoplastic polymers may be used in the form of powders, pellets, granules, or any other melt-processible form. The particular thermoplastic polymer selected for use will depend upon the application or desired properties of the finished product. The thermoplastic polymer may be combined with conventional additives such as light stabilizers, fillers, staple fibers, anti-blocking agents and pigments.

In one embodiment, the polymers include recyclate polymers, such as recycled polyethylene terephthalate, recycled polyethylene, recycled polypropylene, recycled polyvinyl chloride, and/or any other recycled polymer. For the purposes of the present invention, “recyclate” means any raw material processed by recycling methods, and any waste material produced as a result of recycling methods. In one embodiment, the multicomponent structure includes between 1 and 99% recycled content by volume. In another embodiment, the multicomponent structure includes between 25 and 99% recycled content by volume. In yet another embodiment, the multicomponent structure includes between 25 and 75% recycled content by volume. In still another embodiment, the multicomponent structure includes between 25 and 50% recycled content by volume. Processing recyclate via nanolayer processing technology allows the multicomponent structure to meet present and future standards for recycled content imposed by states, such as California's Assembly Bill 793, which is incorporated by reference herein in its entirety. By including recyclate within the nanolayers of the multicomponent structure, the multicomponent structure is able to satisfy recycled content standards while still achieving better mechanical performance than the inclusion of recyclate would normally allow. Specifically, processing materials, miscible or immiscible, have been demonstrated to increase material chemical compatibility and alter composite material properties in the micro- and nanoscale in flat film structures, while the multicomponent structure of the present invention extends those property enhancements from the x-y to the x-y-z plane thereby enabling an even more significant increase in material performance.

In one embodiment, the recyclate includes post-consumer recyclate. The use of post-consumer recyclate is notable, as the workability of post-consumer recyclate and the expected properties from including it are even lower than traditional recyclate, in part due to decreased consistency and increased variability among the post-consumer recyclate in comparison to other recyclate forms.

In one example, the first polymer layer(s) and second polymer layer(s) can be formed from high density polyethylene (HDPE) and the third polymer layers can be formed of ethylene octene copolymer materials (EO).

The multicomponent structure can include, for example, about 1% to about 99% by weight of a combination of the first polymer material and second polymer material and about 1% to about 99% by weight of the third polymer material. The weight ratio or weight percent of the first polymer material to the second polymer material and/or the third polymer material in the multicomponent structure can be adjusted by altering the thicknesses of the first polymer layer and/or the second polymer layer to tailor the mechanical properties of the structure. Additionally, the weight ratio or weight percent of the polymers used to form the first polymer layers, the third polymer layers, and/or the fourth polymer layers can be adjusted by altering the thicknesses of the first polymer layers, third polymer layers, and/or fourth polymer layers to tailor the properties of the structure.

It will be understood, however, that a specific constituent or concentration of the first polymer material, the second polymer material, the third polymer material or any constituent in a multicomponent composite described herein can be adjusted so as to tailor the mechanical or chemical properties for different applications.

The multicomponent structure can be in the form of or formed from a multilayer film or sheet that includes at least two discrete polymer layers (i.e., the first polymer layer and the second polymer layer), for example, at least 10 polymer layers alternating between the first polymer layer and the second polymer layer. The number of layers in the multilayer film or sheet is preferably in the range of from about 2 to about 10,000,000 and more preferably from about 10 to about 2,000,000, including any increments within these ranges. In some embodiments, the multilayer film or sheet can include up to about 2,000,000 layers alternating between the first layer and the second layer.

The vertical polymer layers of the multilayer film or sheet can have thicknesses in the range of, for example, about 5 nanometers (nm) to about 1,000 micrometers (μm) or more. In one embodiment, the vertical polymers layers of the multilayer film or sheet have thicknesses of between about 5 nm and about 20 nm. In one embodiment, the vertical polymers layers of the multilayer film or sheet have thicknesses of between about 250 nm to about 1,000 nm. In one embodiment, the vertical polymers layers of the multilayer film or sheet have thicknesses of between about 500 nm and about 1,000 nm. In one embodiment, the vertical polymers layers of the multilayer film or sheet have thicknesses of between about 250 nm and about 500 nm. In one embodiment, the vertical polymers layers of the multilayer film or sheet have thicknesses of between about 50 nm and about 250 nm. The thicknesses of the first polymer layer(s) and the second polymer layer(s) are such that the final multilayer film or sheet can have a hierarchical structure or gradient structure on a nanometer, micrometer and/or centimeter scale. The number of first polymer layers and second polymer layers employed in the multilayer film or sheet as well as the thicknesses of each of the layer can be selected so that the mechanical properties of the film or sheet is optimized.

The horizontal polymer layers of the horizontal stack of layers can have thicknesses in the range of, for example, about 5 nanometers (nm) to about 500 micrometers (μm). The thicknesses of the third polymer layer(s) and the fourth polymer layer(s) are such that the final multilayer film or sheet can have a hierarchical structure on a nanometer, micrometer and/or centimeter scale. The number of horizontal polymer layers in each second polymer layer as well as the thicknesses of each of the polymer layer can be selected so that the mechanical properties are optimized for the specific application, which the film or sheet is employed.

The multicomponent structure or multilayer film or sheet can also include other polymer layers besides the first polymer layer(s) and the second polymer layer(s). These other layers can be interspersed with the first polymer layers and the second polymer layers to modify the mechanical properties of the structure, film, or sheet. In one example, the first layer (A), the second layer (B), and the addition (i.e., third) layer can be alternated so that the multicomponent layered film has a three component structure of alternating layers (ABCABCABC . . . ) or (ABC)ₓ, where x is at least 5. It will be appreciated that the first layer, second layer, and third layer can be provided any number of different component layers such as (CACBCACBC . . . ).

In another aspect, the layer structure can constitute thickness variation along the Z-direction of the layer stack. The film or sheet can constitute a gradient layer structure or packets of layers with different individual layer thicknesses. The film or sheet can also contain multiple such packets with each packet of layers containing two or more layer thickness variations.

In another aspect, the layer structure can be present with additional layers of the same or different polymer(s) as outside layer(s). The outside layers can be added to provide improved wear resistance to the multicomponent structure. The core layer structure can constitute any of the layer structure morphologies described herein or a single layer constituting one or more polymers and/or fillers discussed herein.

In another aspect, the multicomponent structure can be treated with other techniques, such as cross-linking (gamma radiation), curing or imbibing with other molecules, axially orienting, to further improve the performance, such as mechanical strength.

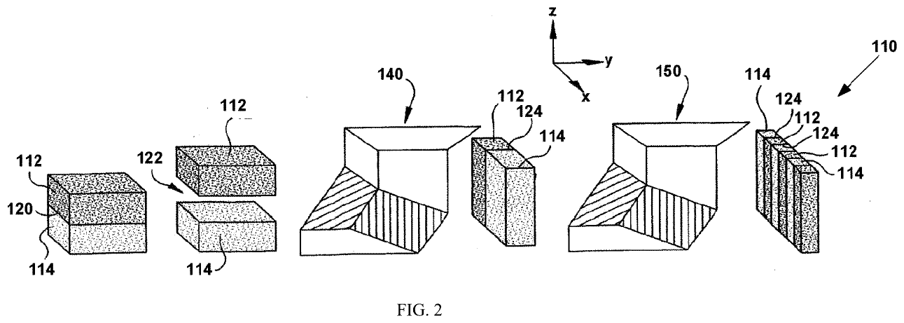

In some embodiments as illustrated in FIG. 2, the multicomponent structure can be prepared by coextruding a first polymer material, a second polymer material, and a third polymer material to form overlapping polymer layers.

The overlapping polymer layers can be multiplied to form horizontal stacks of the polymer layers of the second polymer material and the third polymer material interspersed between layers of the first polymer material. In some embodiments, multiplying the overlapping layers comprises vertical layer multiplication of the overlapping first polymer layer and second polymer layer by cutting the flow horizontally of the overlapping layers through a die, surface layering the overlapping polymers layers on a top and bottom surface of vertical layers formed by the vertical layer multiplication, and horizontal layer multiplication of the surface layered vertical layers to stack one side portion of the surface layered vertical stack on a second side portion. In some embodiments, the vertical layer multiplication is repeated eight times to yield vertical layers composed of 1024 alternating 512 layers of the first layer and 512 layers of second layer.

FIG. 2 illustrates a co-extrusion and multiplying process used to form a multicomponent structure 110, such as a multicomponent film or sheet. First, a first polymer layer 112 and a second polymer layer 114 are provided. The first layer 112 is formed from a first polymer material (a) and the second polymer layer 14 is formed from a second polymer material (b). The second polymer material (b) can have a similar viscosity with the first material (a) when co-extruded. It will be appreciated that one or more additional layers formed from the polymer materials (a) or (b) or a different polymer materials may be provided to produce the multicomponent component 110.

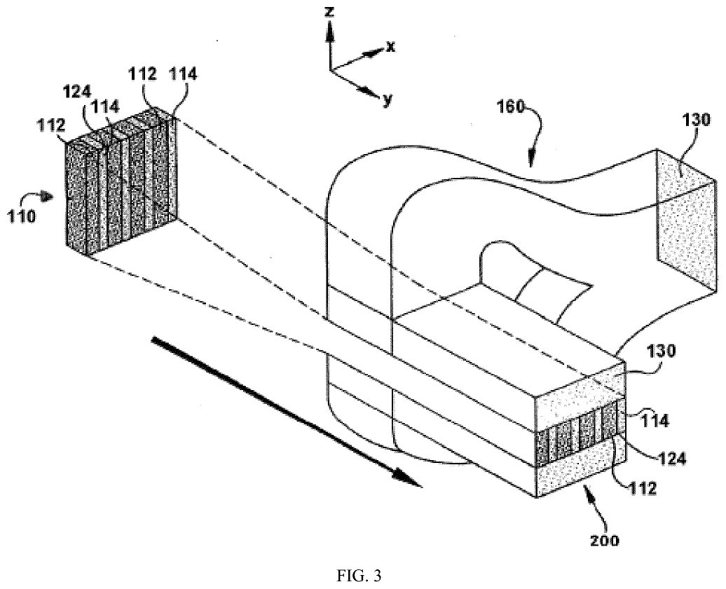

Referring to FIG. 3, the layers 112, 114 are co-extruded and multiplied in order to form the multilayered polymer film or sheet 110. In particular, a pair of dies 140, 150 are used to co-extrude and multiply the layers 112, 114. Each layer 112, 114 initially extends in the y-direction of an x-y-z coordinate system. The y-direction defines the length of the layers 12, 14 and extends in the general direction of flow of material through the dies 140, 150. The x-direction extends transverse, e.g., perpendicular, to the y-direction and defines the width of the layers 112, 114. The z-direction extends transverse, e.g., perpendicular, to both the x-direction and the y-direction and defines the height or thickness of the layers 112, 114.

The layers 112, 114 are initially stacked in the z-direction and define an interface 120 therebetween that resides in the x-y plane. As the layers 112, 114 approach the first die 140 they are separated from one another along the z-axis to define a space 122 therebetween. The layers 112, 114 are then re-oriented as they pass through the first die 140. More specifically, the first die 140 varies the aspect ratio of each layer 112, 114 such that the layers 112, 114 extend longitudinally in the z-direction. The layers 112, 114 are also brought closer to one another until they engage or abut one another along an interface 124 that resides in the y-z plane.

The layers 112, 114 then enter the second die 150 where layer multiplication occurs. The second die 150 may constitute a single die or several dies which process the layers 112, 114 in succession (not shown). Each layer 112, 114 is multiplied in the second die 150 to produce a plurality of first layers 112 and a plurality of second layers 114 that alternate with one another to form the multilayered polymer film or sheet 10. Each pair of layers 112, 14 includes the interface 124 that resides in the y-z plane. The layers 112, 114 are connected to one another generally along the x-axis to form a series of discrete, alternating layers 112, 114 of polymer material (a), (b). Although three of each layer 112 and 114 are illustrated it will be appreciated that the multilayered polymer film or sheet 110 may include, for example, up to thousands of each layer 112, 114.

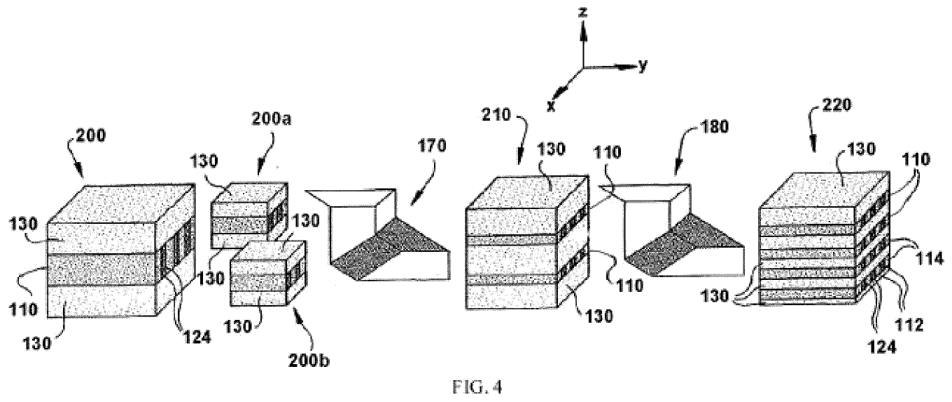

Referring to FIG. 4, once the multilayered polymer film or sheet 110 is formed an outer layer 10 is applied to the top and bottom of the film or sheet 110 such that the film or sheet 110 enters a die 160 where the film or sheet 110 is sandwiched between two outer layers 130 along the z-axis to form a first composite stream 200. The outer layer 130 may be formed from the polymer material (a), the polymer material (b) or a polymer material (c) different from the polymer material (a) and material (b).

Referring to FIG. 4, the first composite stream 200 is divided along the x-axis into a plurality of branch streams 200a, 200b and processed through a pair of multiplying dies 170, 180. In the die 170, the streams 200a, 200b are stacked in the z-direction, stretched in both the x-direction and the y-direction, and recombined to form a second composite stream 210 that includes a plurality of alternating polymer layers 210 alternating with outer polymer layers 130. Biaxial stretching of the branch streams 200a, 200b in the x-direction and y-direction may be symmetric or asymmetric.

The die 180 performs similar modifications to the second composite stream 210 that the die 170 performed on the branch streams 200a, 200b. In particular, in the die 180 the second composite stream 210 is divided along the x-axis, stacked along the z-axis, stretched in both the x-direction and the y-direction, and stacked in the z-direction to form a third composite stream 220. The third composite stream 220 shown in FIG. 4 includes four multilayered films or sheets 110 that alternate with five outer layers 130, although more or fewer of the films or sheets 110 and/or layers 130 may be present in the third composite stream 220. Regardless, the third composite stream 220 includes a plurality of layer interfaces 124 between the layers 112, 114.

In one embodiment, the structure includes at least 8 layers.

By changing the volumetric flow rate of the polymer layers 112, 114 through the dies 170, 180, the thickness of both the polymer layers 112, 114 and each multilayered film or sheet 110 in the z-direction can be precisely controlled.

The multilayered film or sheet so formed includes a vertical stack of adjoining first polymer layers and second polymer layers that define a generally planar interface therebetween, which lies generally in an x-y plane of an x-y-z coordinate system. The second polymer layers of the vertical stack can include a horizontal stack of discrete polymer layers with polymer layer interfaces extending transverse to the x-y plane. The polymer material of one of the alternating polymer layers of the horizontal stack of discrete polymer layers is processable with the polymer material of the of the first polymer layers and processable with a second polymer material of the other polymer layers of the horizontal stack such that the other polymer layers form polymer fiber-like reinforcement layers having a rectangular cross-section that extend substantially parallel to the x-y plane in a polymer matrix defined in part by the first polymer material and the second polymer material, in effect forming a polymer reinforced structure or substrate.

In some embodiments, the mechanical properties of the multicomponent reinforced structure so formed can be varied mechanically by axially orienting (e.g., stretching), pressure, tension, compression or shear stresses or a combination of these stresses. As pointed out above, the composite can be fabricated so that one or both of the component polymers is an elastomer. Axial orientation of the multicomponent film or sheet in at least one direction parallel to the surface of the film or sheet can in some instances increase or improve the mechanical strength or toughness of the film or sheet. In one example, the multicomponent composite can be uniaxially oriented by stretching the film or sheet in a plane that is substantially parallel to a surface of the film or sheet at a draw ratio effective to increase the mechanical strength of the film or sheet. The draw ratio of the uniaxially oriented multilayer polymer film or sheet can be about 1:1 to about 1:50. It will be appreciated that although the film or sheet can be uniaxially oriented by stretching the film or sheet in at least two one direction, the film or sheet can also be stretched in a two directions (e.g., biaxially oriented) or stretched in multiple directions (e.g., triaxially oriented).

Prior to mechanically manipulating and/or mechanical manipulation of the multicomponent structure by, for example, axial orientation. The multicomponent structure can be consolidated with heat and/or pressure to cause further diffusion and/or adherence of the substantially first polymer material and the second polymer material that forms the polymer matrix. Consolidation can be conducted at a temperature that is above the T_{g} and of both the first polymer material, second polymer material, and third polymer material to promote diffusion of first polymer material with the second polymer material. The consolidation temperature upper limit is affected by the pressure of consolidation and the residence time of consolidation. For example, a higher consolidation temperature may be used if the pressure used is high and the residence time is short. If the consolidation is conducted at too high a temperature, too high a pressure and/or too long a residence time, the reinforcement polymer layers might melt into larger structures or revert into discontinuous or continuous spheres.

A number of designs of the multicomponent structure are possible by choosing the appropriate initial materials and tailoring the initial material, number of layers, and thicknesses of the layers. For example, the multicomponent structure can be formed using melt processable inorganics instead of or together with melt processable polymer materials. The melt processable inorganics can be potentially extruded, coextruded, laminated, and/or 3D-printed similar to the polymer materials.

In some embodiments, the fiber-like reinforcements of the multicomponent structures, films, and/or sheets described herein can provide the structures, films, and/or sheets with improved mechanical properties including increased elastic modulus, improved dimensional stability, and reduced variability of properties due to either process variations or thermal history, compared to structures, films, and/or sheets that do not include such reinforcements.

### Example

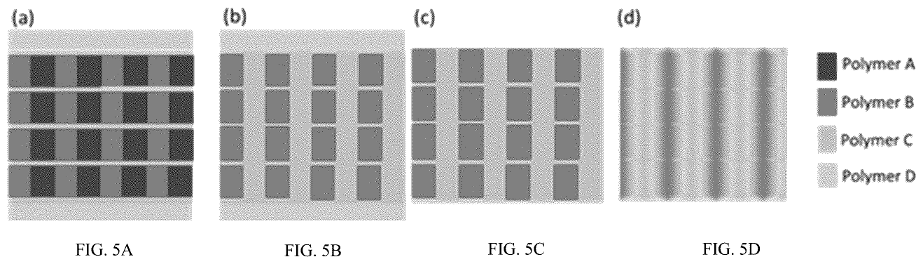

This example describes a multilayer coextrusion process, typically used to fabricate layered films, sheets, or structures with component layers parallel to the film plane that has been modified to create structures with vertical layers perpendicular to the film or sheet plane. The vertical layer stack can further be separated by another polymer to create fiber-like geometry of the layers. Further development work led to creation of polymer structures, where one polymer can form a matrix while another component forms reinforcement layers with rectangular cross section (2D structure), depicted in FIGS. 5A-D. The following process can improve mechanical performance of 2D layer structure where compatible or partially compatible component polymers were selected to achieve improved toughness, ballistic, fracture, impact and other mechanical properties over conventional layer composites and blends.

Multicomponent multilayer films or sheets containing two or more polymers can be fabricated using modified coextrusion set-up to create various structures as shown in FIGS. 5A-D. Examples of composites containing between two to four polymers are shown. Typical modified structure constituted vertical layer stacks two polymers (Polymer A and B) separated by a third polymer (Polymer C), while a provision for additional polymer skin layer (Polymer D) was also demonstrated. When the polymers are compatible, a partial miscibility at the interfaces can create diffused boundaries as shown in FIG. 5D.

FIG. 5 illustrates films with different geometric structures fabricated to evaluate the mechanical properties of the oriented films or sheets. A 2D layer structure, as shown in FIG. 1, with High density polyethylene (HDPE) and ethylene-octene copolymer (EO) materials, with EO polymer as a layer separating vertical layer stacks, was fabricated. A blend sample of the HDPE and EO with similar composition was also fabricated. The mechanical performance of the processed films with different structures did not show a significant change. However, when the samples were oriented uniaxially, a significant improvement in the mechanical properties of films containing 2D structure as compared to blend samples as well as films containing 1D layer structure was observed. The mechanical properties of the oriented films are summarized in Table 1. It is observed that the Young's modulus of the oriented 2D layer structure is at least 3 times higher than oriented blend or 1D layer film system. Because the Young's Modulus and the yield strength of the 2D layer structure are observed to increase relative to the oriented blend or 1D layer film system, the overall toughness of the 2D layer structure is also greater than that of the oriented blend or 1D layer film system. Furthermore. Increasing the number of layers in the 2D structure also improved the mechanical properties of the oriented film samples. This approach can be used to fabricate tougher polymer composite systems for various applications including but not limited to ballistics, packaging, automotive and consumer products.

TABLE 1
Mechanical properties of oriented HDPE/EO systems

| | | | | HDPE | EO | | Modulus | Stress |
|---|---|---|---|---|---|---|---|---|
| | | | | Layer | Layer | Young's | Secant | at |
| | | Composition | | Dimension | Dimension | Modulus | 2% | Break |
| No. | Samples | (v/v)% | Layers | (μm × μm) | (μm × μm) | (MPa) | (MPa) | (MPa) |
| 1 | HDPE/EO | 80/20 | — | — | — | 1,274 | 1,326 | 214 |
| | Blend | | | | | | | |
| 2 | HDPE/EO | 80/20 | 16 | 16 | 4 | 1,158 | 424 | 100 |
| | (1D) | | | | | | | |
| 3 | HDPE/EO | 80/20 | 1024 × 16* | 15 × 8 | 4 × 8 | 2,995 | 1,425 | 362 |
| | (2D) | | | | | | | |
| 4 | HDPE/EO | 80/20 | 2048 × 32* | 7 × 5 | 2 × 5 | 3,810 | 3,177 | 306 |
| | (2D) | | | | | | | |

*First number represents number of vertical layers, second number represents number of vertical layer stacks in the film

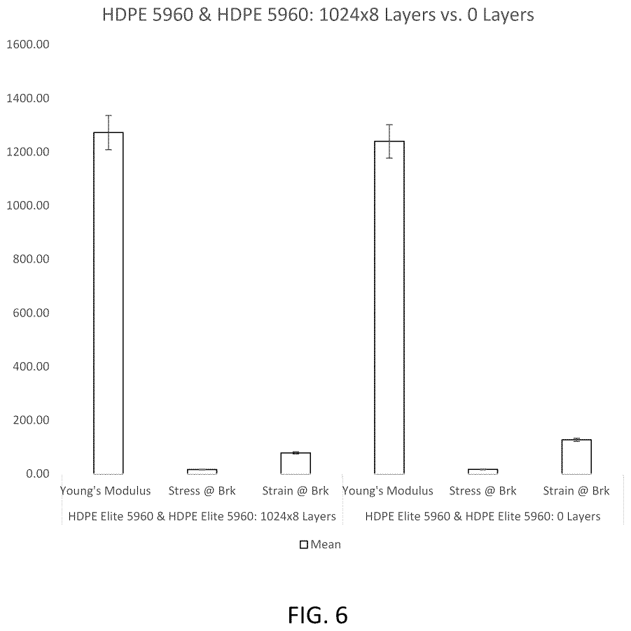

The increase in mechanical properties is an unexpected benefit of the layering process and does not emerge for all materials, or even all miscible materials, but only in layered versions of certain combinations of materials. FIGS. 6-13 demonstrate the material specificity of the present invention, demonstrating that combinations of just high density polyethylene (HDPE) (which is necessarily miscible with itself) do not demonstrate significant improvements in mechanical properties with layering, while combinations of HDPE and ethylene vinyl alcohol (EVOH), which are also miscible, do demonstrate such improvements.

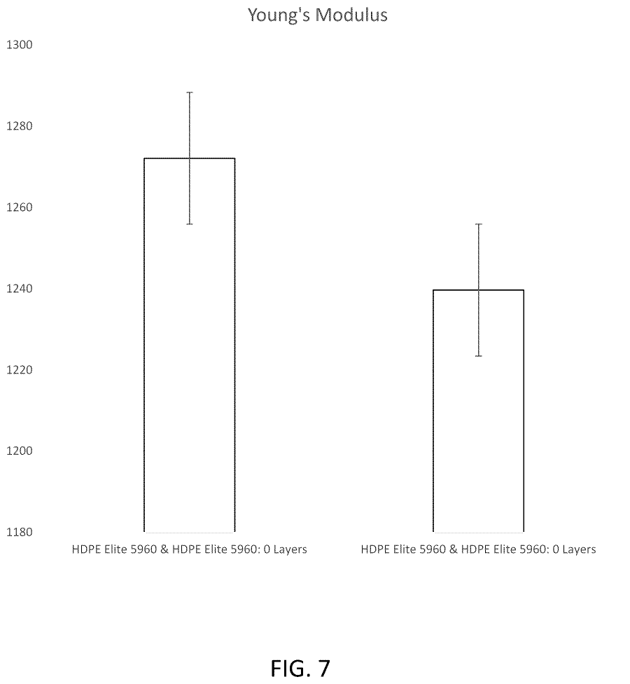

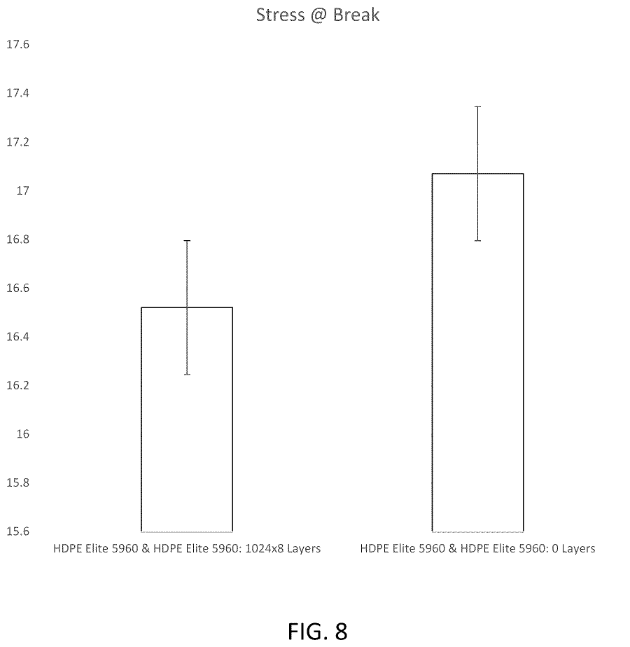

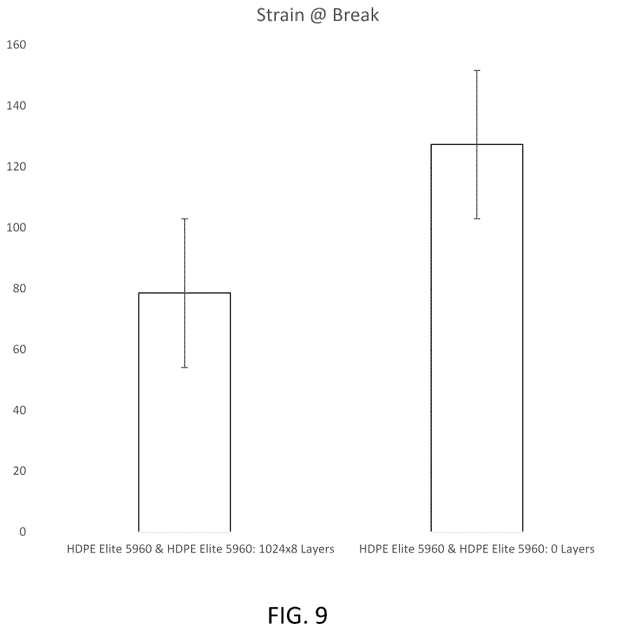

FIGS. 6 and 7 show that the layering of HDPE, specifically with 1024 vertical layers and 8 horizontal layers only produced a 2.5% increase in Young's Modulus compared to an unlayered HDPE sample, within the standard deviation, and therefore not providing a significant improvement. Similarly, FIGS. 8 and 9, respectively, show that the increase in stress for the layered structure is only about 3.3% and the difference in strain is only about 62.1%, both of which are within the standard deviation. Not only is the difference not significant, but, if anything, the layered structure in this case shows a decrease in both ultimate stress and strain. These values are further shown in Table 2 below.

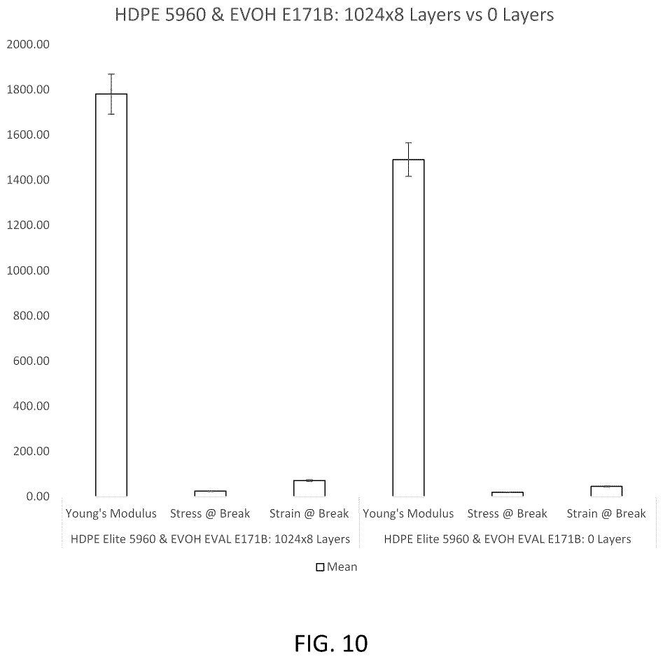

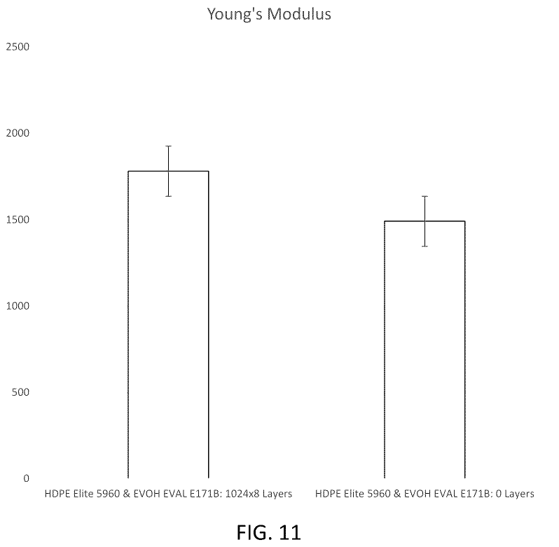

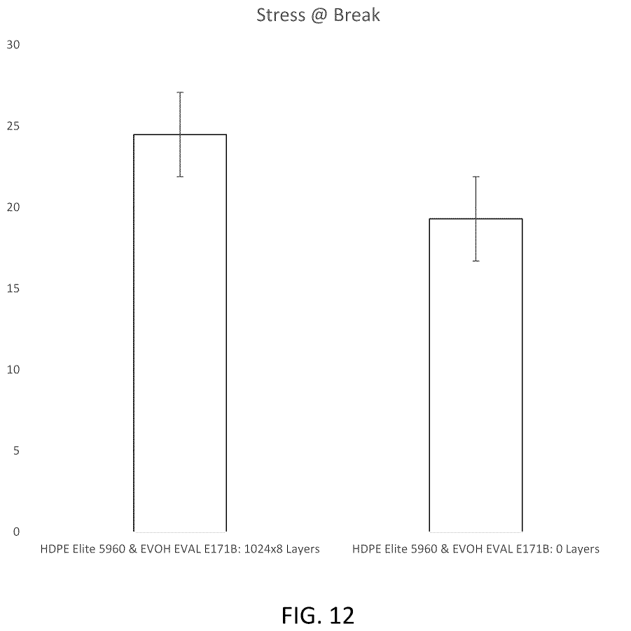

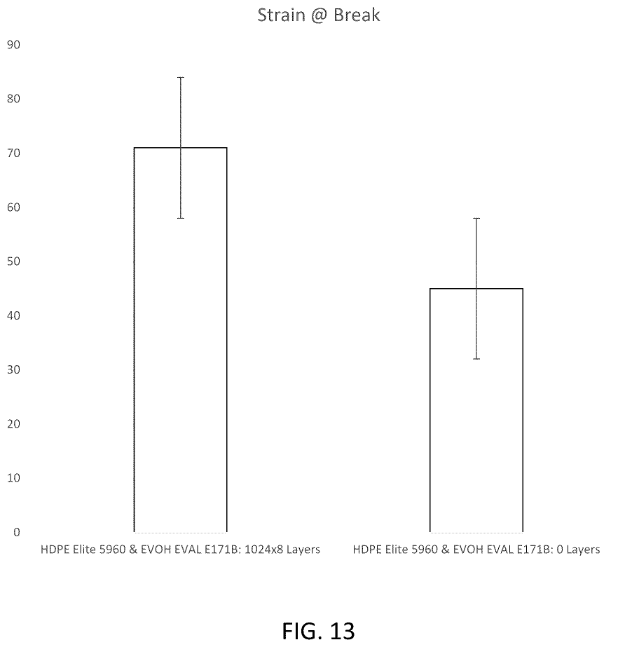

FIGS. 10-13, on the other hand, show that layering of HDPE and EVOH, two other miscible polymers, do show a significant increase in mechanical properties with layering, as opposed to an unlayered structure of the same materials (at the same percentages). FIGS. 10 and 11 show a 16.3% increase in Young's modulus, nearly ten times the delta shown in the pure HDPE structures. Furthermore, FIGS. 12 and 13, respectively, show an increase, as opposed to a decrease, in stress (21.2%) and strain for the layered structure (36.6%). These values are reflected in Table 3 below.

TABLE 2
Comparison of Mechanical Properties for Layered vs. Un-layered HDPE

| | HDPE Elite 5960 & HDPE | | | HDPE Elite 5960 & HDPE | | |
|---|---|---|---|---|---|---|
| | Elite 5960: 1024 × 8 Layers | | | Elite 5960: 0 Layers | | |
| | Young's | Stress @ | Strain @ | Young's | Stress @ | Strain @ |
| | Modulus | Break | Break | Modulus | Break | Break |
| Mean | 1272 | 16.5 | 78.5 | 1239.6 | 17.1 | 127.3 |
| Standard | 55 | 0.8 | 31.0 | 64.8 | 1.1 | 91.9 |
| Deviation | | | | | | |

TABLE 3
Comparison of Mechanical Properties for Layered
vs. Un-layered HDPE/EVOH structure

| | HDPE Elite 5960 & EVOH EVAL | | | HDPE Elite 5960 & EVOH EVAL | | |
|---|---|---|---|---|---|---|
| | E171B: 1024 × 8 Layers | | | E171B: 0 Layers | | |
| | Young's | Stress @ | Strain @ | Young's | Stress @ | Strain @ |
| | Modulus | Break | Break | Modulus | Break | Break |
| Mean | 1781 | 24.5 | 71.0 | 1491 | 19.3 | 45.0 |
| Standard | 260 | 6.6 | 44.5 | 56 | 2.3 | 22.5 |
| Deviation | | | | | | |

These results show that while miscibility is important to achieve the resulting structure of the present invention, these improvements are not simply the logical consequence of miscibility for any and all materials, instead showing a particular benefit to the combinations described herein.

Preferably, the polymer structures of the present invention are not conductive and do not include any electrically conductive additives. In one embodiment, the polymer structures are insulators. In one embodiment, the polymer structures are not conductors and/or are not semiconductors. In one embodiment, the polymer structures have a band gap greater than 5V. In one embodiment, the polymer structures have an electrical resistivity of at least 100 ohm-m. In one embodiment, the polymer structures have an electrical resistivity of at least 1,000 ohm-m. In one embodiment, the polymer structures have an electrical resistivity of at least 105 ohm-m. In one embodiment, the polymer structures have an electrical resistivity of at least 108 ohm-m.

The preferred embodiments of the invention have been illustrated and described in detail. However, the present invention is not to be considered limited to the precise construction disclosed. Various adaptations, modifications and uses of the invention may occur to those skilled in the art to which the invention relates and the intention is to cover hereby all such adaptations, modifications, and uses which fall within the spirit or scope of the appended claims.

The invention claimed is:

1. A multicomponent structure, comprising:
a multicomponent substrate having a plurality of vertical layers, including at least one first layer and at least one second layer;
wherein the at least one first layer comprises a first polymer and the at least one second layer comprises a second polymer;
wherein the multicomponent structure is formed such that a volume ratio of the first polymer to the second polymer is approximately equal to a preset value;
wherein the at least one second layer includes a plurality of horizontal layers;
wherein the multicomponent structure includes at least one recyclate;
wherein the plurality of horizontal layers alternate between polymer matrix layers and fiber reinforcement layers, wherein the fiber reinforcement layers include fibers extending through a length of the multicomponent structure; and
wherein the multicomponent structure is not electrically conductive and does not include any electrically conductive additives.

2. The multicomponent structure of claim 1, wherein the at least one first layer and the at least one second layer are alternating layers within the multicomponent structure.

3. The multicomponent structure of claim 1, wherein the Young's modulus of the multicomponent structure is greater than a blended structure having the same volume ratio of the first polymer to the second polymer as the multicomponent structure.

4. The multicomponent structure of claim 1, wherein the toughness of the multicomponent structure is greater than a blended structure having the same volume ratio of the first polymer to the second polymer as the multicomponent structure.

5. The multicomponent structure of claim 1, wherein the at least one first layer and/or the at least one second layer include at least 25% recyclate by volume.

6. The multicomponent structure of claim 1, wherein the at least one first layer and/or the at least one second layer include at least 50% recyclate by volume.

7. The multicomponent structure of claim 1, wherein the plurality of vertical layers includes between about 2 to about 2,000,000 layers.

8. The multicomponent structure of claim 1, wherein the thickness of each of the plurality of vertical layers is between about 5 nm and 1,000 nm.

9. The multicomponent structure of claim 1, wherein the plurality of vertical layers do not have substantially equal thicknesses.

10. The multicomponent structure of claim 1, wherein the first polymer and the second polymer are miscible such that the at least one first layer and at least one second layer adhere to each other.

11. A multicomponent structure, comprising:
a multicomponent substrate having a plurality of vertical layers, including at least one first layer and at least one second layer;
wherein the at least one first layer comprises a first polymer and the at least one second layer comprises a second polymer;
wherein the multicomponent structure is formed such that a volume ratio of the first polymer to the second polymer is approximately equal to a preset value;
wherein the at least one second layer includes a plurality of horizontal layers;
wherein the plurality of horizontal layers alternate between polymer matrix layers and fiber reinforcement layers, wherein the fiber reinforcement layers include fibers extending through a length of the multicomponent structure;
wherein the toughness of the multicomponent structure is greater than a one-dimensional (1D) layered structure having the same volume ratio of the first polymer to the second polymer material as the multicomponent structure; and
wherein the multicomponent structure is an insulator.

12. The multicomponent structure of claim 11 wherein the at least one first layer and the at least one second layer are alternating layers within the multicomponent structure.

13. The multicomponent structure of claim 11, wherein the at least one first layer and/or the at least one second layer include recyclate.

14. The multicomponent structure of claim 11, wherein the at least one first layer and/or the at least one second layer include at least 25% recyclate by volume.

15. The multicomponent structure of claim 11, wherein the at least one first layer and/or the at least one second layer include at least 50% recyclate by volume.

16. The multicomponent structure of claim 11, wherein the Young's modulus of the multicomponent structure is greater than a 1D layered structure having the same volume ratio of the first polymer to the second polymer as the multicomponent structure.

17. The multicomponent structure of claim 11, wherein the plurality of vertical layers includes between about 2 to about 2,000,000 layers.

18. The multicomponent structure of claim 11, wherein the thickness of each of the plurality of vertical layers is between about 5 nm and 1,000 nm.

19. The multicomponent structure of claim 11, wherein the first polymer and the second polymer are miscible such that the at least one first layer and at least one second layer adhere to each other.

20. A multicomponent structure, comprising:
a multicomponent substrate having a plurality of vertical layers, including at least one first layer and at least one second layer;
wherein the at least one first layer comprises a first polymer and the at least one second layer comprises a second polymer;
wherein the at least one second layer includes a plurality of horizontal layers;
wherein the multicomponent structure includes at least one recyclate;
wherein the plurality of horizontal layers alternate between polymer matrix layers and fiber reinforcement layers, wherein the fiber reinforcement layers include fibers extending through a length of the multicomponent structure;
wherein the plurality of vertical layers do not have substantially equal thicknesses; and
wherein the multicomponent structure is not electrically conductive and does not include any electrically conductive additives.
